(19) United States
(12) Patent Application Publication
(10) Pub. No.: US 2005/0198518 A1
(43) Pub. Date: Sep. 8, 2005

(54) Method for blocking Spam

(75) Inventors: Leonid Kogan, Yoqne'Am Ilit (IL); Shimon Gruper, Kiriat Haim (IL); Yanki Margalit, Ramat-Gan (IL); Dani Margalit, Ramat-Gan (IL)

Correspondence Address: DR. MARK FRIEDMAN LTD.;C/o Bill Polkinghorn, Discovery Dispatch, 9003 Florin Way, Upper Marlboro, MD, 20772, US

(73) Assignee: ALADDIN KNOWLEDGE SYSTEMS LTD.

(21) Appl. No.: 10/759,017

(22) Filed: Jan. 20, 2004

(51) Int. Cl. H04L 9/32

(52) U.S. Cl. 713/188; 726/22

(57) ABSTRACT

A method for blocking Spam sent to an email address of an individual, comprising: establishing an intermediating email address, for corresponding with a party of interest without revealing the permanent email address of the individual; indicating an email message sent to the intermediating email address as Spam unless the sender thereof is the party of interest. On indicating an email message as Spam, blocking the email message. On indicating an email message as non-Spam, redirecting the email message to the permanent email address of the individual. In one embodiment of the invention, the intermediating email address expires after a predefined or arbitrary period. The method may be implemented by an email client associated with the intermediating email address, an email server, a proxy server, a gateway server and so forth.

### FIELD OF THE INVENTION

The present invention relates to the field of Spam mail. More particularly, the invention relates to a method for blocking Spam mail.

### BACKGROUND OF THE INVENTION

The term “Spam” is referred in the art to unsolicited bulk email message, or “junk” email message, i.e. an un-requested email message that is sent to recipient(s), with the purpose of promoting a business, idea, service and so forth. Spam is also used by hackers to spread vandals and viruses, or to trick users into visiting hostile or hacked sites, which will attack innocent surfers. Spam usually promotes “get rich quick” schemes, porn sites, travel/vacation services and a variety of other topics.

Currently there are some common ways of blocking Spam, each one having its-own advantages and drawbacks. For example, a well-known way of blocking Spam is maintaining a “black list” of Spammers, in which an email user can determine to the email client (e.g. Outlook, Hotmail Web page) or server that a certain email address belongs to a Spammer, and thereby prevent the arrival of subsequent email messages from this email address to his inbox folder. At the user's side, instead of placing Spam messages in the inbox folder, Spam messages are sent to a dedicated folder, allowing the user to review, delete or ignore its messages. Typically, Spam messages are removed from the Spam folder after a few days.

The eSafe Gateway and the eSafe Mail of Aladdin Knowledge Systems are examples of products that block incoming and/or outgoing email messages. The blocked messages are based on the sender's/recipient's email address, detecting certain text within a message and so forth. Organization administrators can block or get a copy of mail messages containing certain text, thereby refining the blocking operation.

According to Jupiter Research, in 2001 U.S. consumers received over 140 billion Spam messages and since then, the average amount of Spam per user has increased from 3.7 to 6.2 email messages per day. Jupiter Research predict that by 2007, Spam email will increase significantly, reaching more than 645 billion messages. This means that the average Internet user will receive up to 3,900 Spam messages a day. Even if it only takes one second for an individual to delete a Spam message, it would still take one hour every day to manually remove Spam.

It is therefore an object of the present invention to provide a novel method for blocking Spam.

Other objects and advantages of the invention will become apparent as the description proceeds.

### SUMMARY OF THE INVENTION

A method for blocking Spam sent to an email address of an individual, comprising: establishing an intermediating email address, for corresponding with a party of interest without revealing the permanent email address of the individual; indicating an email message sent to the intermediating email address as Spam unless the sender thereof is the party of interest. On indicating an email message as Spam, blocking the email message. On indicating an email message as non-Spam, redirecting the email message to the permanent email address of the individual. In one embodiment of the invention, the intermediating email address expires after a predefined or arbitrary period. The method may be implemented by an email client associated with the intermediating email address, an email server, a proxy server, a gateway server and so forth.

### BRIEF DESCRIPTION OF THE DRAWINGS

The present invention may be better understood in conjunction with the following figures:

FIG. 1 schematically illustrates the operation and infrastructure of e-mail delivering and blocking, according to the prior art.

FIG. 2 schematically illustrates the way Spam is propagated to innocent users.

FIG. 3 schematically illustrates a deployment of email addresses, according to a preferred embodiment of the invention.

FIG. 4a is a flowchart of the preliminary stage of a method for blocking Spam, according to a preferred embodiment of the invention.

FIG. 4b is a flowchart of the blocking stage of a method for blocking Spam, according to a preferred embodiment of the invention.

FIG. 5 is an illustration of the user interface of Outlook Express email client, administrating a plurality of email accounts. The present interface may be implemented in conjunction with the present invention.

### DETAILED DESCRIPTION OF PREFERRED EMBODIMENTS

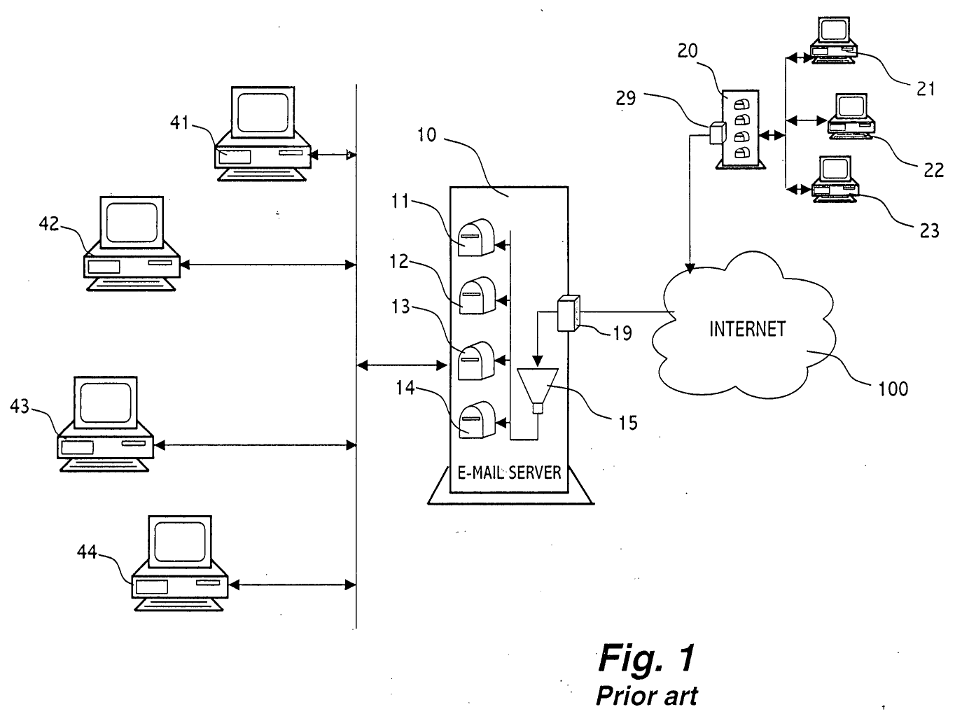

FIG. 1 schematically illustrates the operation and infrastructure of e-mail delivering and blocking, according to the prior art. A mail server 10 maintains e-mail accounts 11 to 14, which belongs to users 41 to 44 respectively. Another mail server 20 serves users 21 to 23. The mail server 10 also comprises an e-mail blocking facility 15, for detecting the presence of malicious code within incoming e-mail messages. A mail server communicates with another mail server by a Mail Transfer Agent (MTA). The MTA can be a part of the mail server or a separate entity.

Referring to FIG. 1, mail server 10 is coupled with an MTA 19, by which it communicates with the MTA 29 of mail server 20 through the Internet 100.

An e-mail message sent from, e.g., user 21 to, e.g. user 42, passes through the mail server 20, through the Internet 100, until it reaches to mail server 10. At the mail server 10 the e-mail message is scanned by the blocking facility 15, and if no malicious code is detected, then it is stored in e-mail box 12, which belongs to user 42. The next time user 42 opens his mailbox 12 he finds the delivered e-mail message.

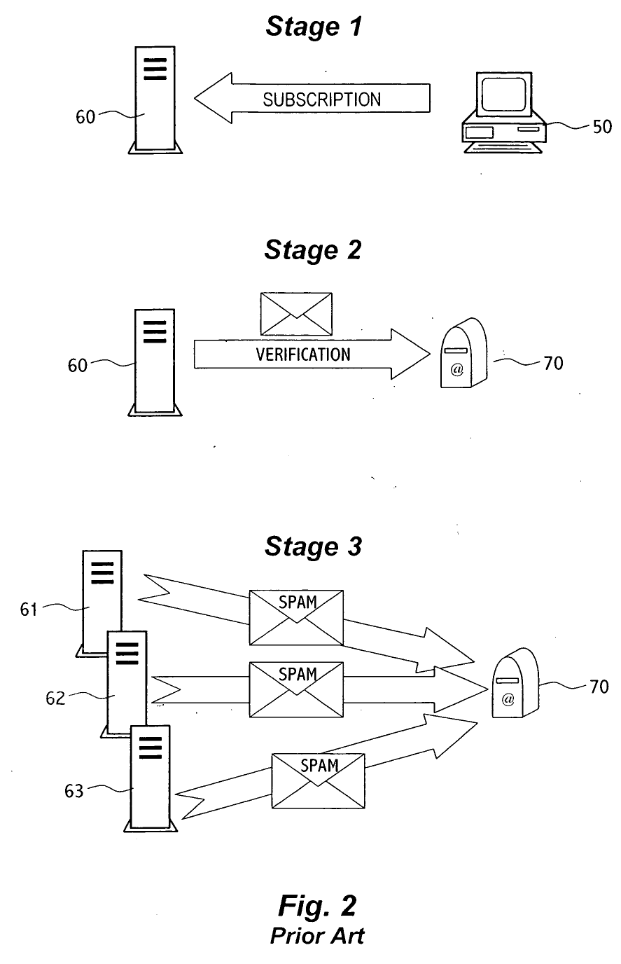

FIG. 2 schematically illustrates the way Spam is propagated to innocent users.

At stage 1, a user employing a computer 50 communicates with a server 60 over the Internet (not shown), in order to subscribe to a service, e.g. a Web magazine. As a part of the subscription, the user provides his email address to the server 60.

At stage 2, the provided email address is verified by the Web server 60 by sending to this email address an email message comprising a verification code. The user has to input the verification code next time he enters the Web magazine. This way the Web server assures that the provided email address is not fake.

At stage 3, the user's email address is provided to other parties. The other parties send Spam to the provided email address by the Web servers 61, 62 and 63. Typically the third parties provide the email address to other parties and so forth.

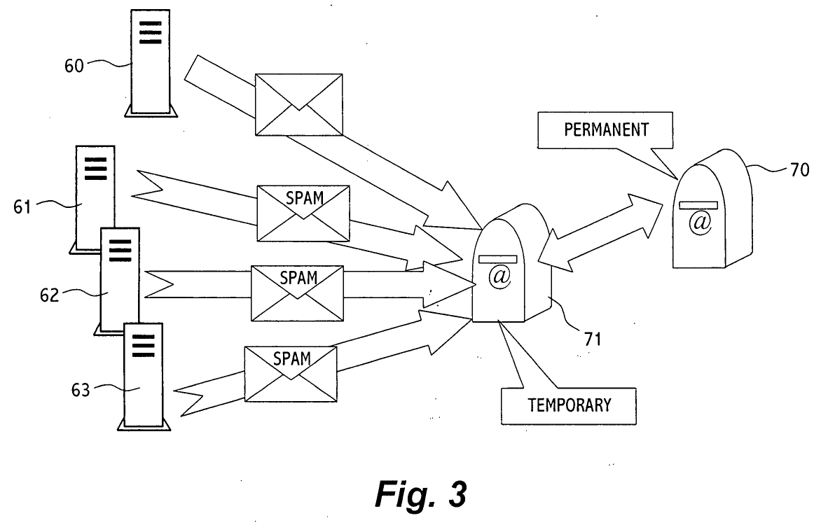

FIG. 3 schematically illustrates a deployment of email addresses, according to a preferred embodiment of the invention. A user having a permanent email address 70 uses a temporary email address 71 (referred herein also as intermediating email address) for subscribing to a service. The temporary email address 71 is propagated by the server 60 which is operated by the service provider, to other parties. Usually information of existing email addresses is traded between objects of interest. As a result, Spam mail is sent via Web servers 61, 62 and 63 to the temporary email address 71. However, since the temporary email address 71 is dedicated only for corresponding with the provider, every email message received to this email address which comes from other email addresses can be indicated as Spam.

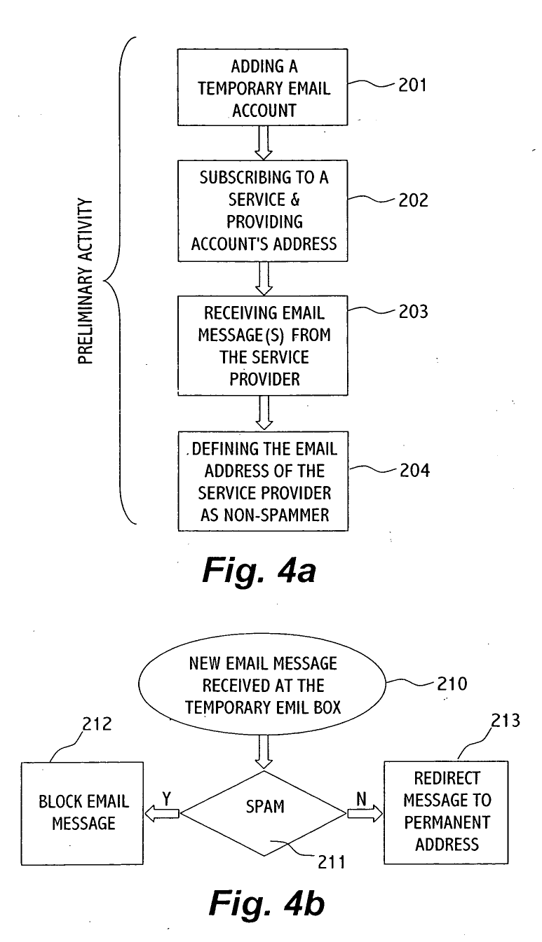

FIG. 4a is a flowchart of the preliminary stage of a method for blocking Spam, according to a preferred embodiment of the invention.

At 201, a user adds a temporary email account to his email accounts, in order to be used by the user for subscribing to a service through the Internet. At this stage, the temporary email account is directed to treat all the incoming email messages as Spam.

At 202, the user subscribes to the service through the Internet. As a part of the subscription process, the user provides the email address of the temporary email account, instead of his permanent email account, as he used to do.

At 203, the service provider verifies that the provided email account is not a fake, since users used to provide fake email addresses on subscription. Fake addresses provided by users may be non-existing email addresses, or email addresses that do not belong to the user and so forth. Service 10 providers used to verify that a provided email addresses is authentic by sending a verification code to the provided email address. Next time the user logs on to the service, he is authenticated by the verification code.

At 204, upon receiving an email from the service provider, the user defines the address of the sender as a non-Spammer (referred herein also as “trusted”) email address. Thus, all the incoming email messages are related by the created email account as Spam, except email messages received from the service provider.

FIG. 4b is a flowchart of the blocking stage of a method for blocking Spam, according to a preferred embodiment of the invention.

At 210, a new email message is received in the temporary mailbox.

From 211, if the email is indicated as Spam (e.g. by the absence of the sender's email address at the non-Spammers email address list), the email message is blocked (at 212), otherwise the received mail message is considered as received from a trusted sender. In this case the email message may be redirected 213 to the permanent email address, sent to the inbox of the temporary email account instead of the bulk mail box, etc.

In some cases the user may decide to cancel the temporary account after a while (hours, days, moths, etc.). This way the user thereof won't be bothered again either by receiving advertising material from the service provider or someone else. According to one embodiment of the invention, the user may define at the opening of the temporary account the existence period of the account.

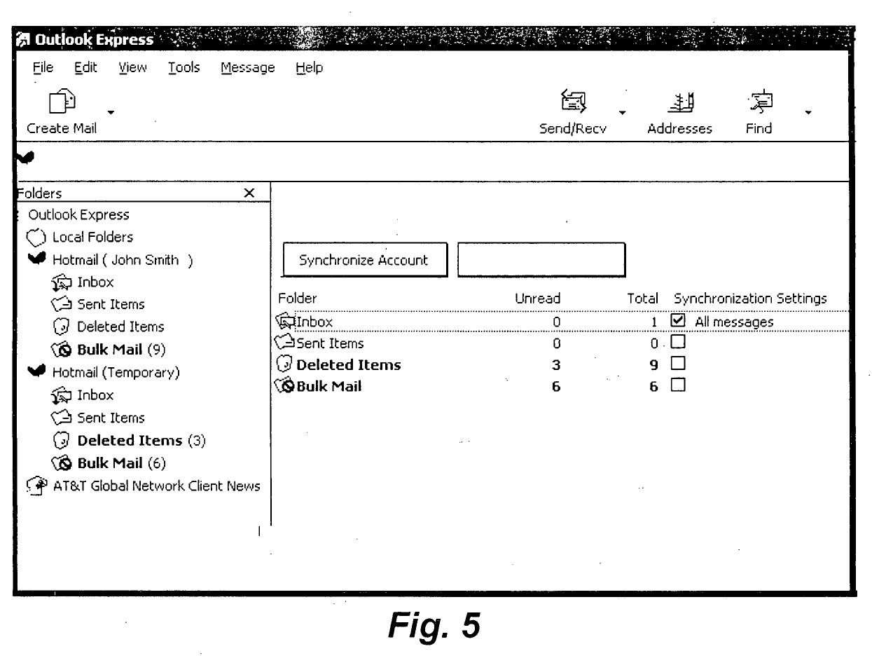

FIG. 5 is an illustration of the user interface of Outlook Express email client, administrating a plurality of email accounts. The present invention may be implemented in conjunction with the present interface. In this example, the user administrates a permanent email account identified as “John Smith” and a temporary email account identified as “Temporary”. Each account has some folders, e.g. Inbox, Sent Items, Deleted Items, Bulk Mail, etc.

Under this kind of user interface, a user may maintain a plurality of accounts, where some of them are temporary accounts, some of them permanent accounts, etc.

According to another embodiment of the invention, the user interface presents only permanent account(s). In this case, trusted incoming email messages sent to the temporary email account(s) are redirected to a permanent account, while Spam messages are removed, ignored, etc.

The minimum requirements from a temporary email account are:
a unique email address; and
a mechanism for indicating a Spam message according to the absence of the sender in a list of trusted senders.

In a further implementation, the intermediating email account forwards email messages form a trusted source to the permanent email address of a user. In other words, in this case the intermediating email address is “transparent”—the user uses his permanent account to correspond with the trusted correspondent, however the email address of the outgoing messages is the intermediating email address. The mechanism for converting the sender's email address can be carried out by the user's email server and/or by the user's email client.

It should be noted that the invention can be implemented by an email client as well as by an email server, or even the functionality thereof can be carried out partly by an email client and partly by an email server.

It also should be noted that a trusted sender can be indicated not only by its full email address, but also by his domain, a part of his email address, the content of the email message, and so forth. For example, if the address of the Web site of a service provider is www.bot-service.com, then the user may instruct the blocking facility (i.e. the filter operating at the email client, email server, gateway, etc.) to classify any email from hot-service.com (e.g. info@hot-service.com or John@sever1.hot-service) as non-Spam. Moreover, the user may instruct the blocking facility to indicate any email message comprising the text “hot-service” as non-Spam, even if the text appears in the body of the message, in a certain field of the email message and so forth.

Also it should be noted that the user's permanent and temporary accounts 25 may be administrated by the same email client, e.g. in the way it is carried out by the email client software Outlook Express.

The term “Gateway” is referred in the art as a bridge between two networks. It is often associated with both a router, which knows where to direct a given packet of data that arrives at the gateway, and a switch, which furnishes the actual path in and out of the gateway for a given packet. A gateway is a perfect point for deploying filtering facilities for preventing entering or of unwanted data from one network to another, like firewalls. As such, a gateway is a suitable point for analyzing email messages arriving to an organization.

Those skilled in the art will appreciate that the invention can be embodied by other forms and ways, without losing the scope of the invention. The embodiments described herein should be considered as illustrative and not restrictive.

1. A method for blocking Spam sent to a first email address, said method comprising the steps of:
creating a second email address, for corresponding with at least one second party while concealing said first email address, said second email address and said first email address having a common denominator;
indicating an email message sent to said second email address as Spam if an identity of the sender thereof is not said at least one second party;
on indicating said email message as Spam, blocking said email message; and
on indicating said email message as non-Spam, redirecting said email message to said first email address.

2. A method according to claim 1, wherein said identity of the sender thereof is indicated as said second party by a member of the group comprising: an email address of said email message, a domain of said email address, certain text within the content of said email message, certain text within a field of said email message.

3. A method according to claim 1, wherein said first email address and said second email address are administered by different email accounts.

4. A method according to claim 1, further comprising the step of: expiring said second email address after a time period selected from the group consisting of: predefined time period, arbitrary time period.

5. A method according to claim 1, wherein said indicating an email message sent to said second email address as Spam is carried out at a point selected from the group comprising: an email client associated with said second email address, an email server, a proxy server and a gateway server.

6. A method according to claim 1, wherein said blocking of said email message is carried out at a point selected from the group comprising: an email client associated with said second email address, an email server, a proxy server and a gateway server.

7. A method according to claim 1, wherein said second email address is rendered transparent to said second party.

8. A method according to claim 1, wherein said blocking is effected by a method selected from the group comprising: deleting said email message, placing said email message in a separate folder and allowing the user to review, delete or ignore the message and further to remove the Spam from said folder.

9. A method according to claim 1, wherein said common denominator is selected from the group comprising: the same owner, the same user name, the same email account.
